(19) United States
(12) Patent Application Publication
(10) Pub. No.: US 2019/0043154 A1
(43) Pub. Date: Feb. 7, 2019

(54) CONCENTRATION BASED ADAPTIVE GRAPHICS QUALITY

(71) Applicant: Intel Corporation, Santa Clara, CA (US)

(72) Inventor: Sean Lawrence, Bangalore (IN)

(21) Appl. No.: 15/854,572

(22) Filed: Dec. 26, 2017

(51) Int. Cl. G06T 1/20; G09G 5/36; G06F 3/01

(52) U.S. Cl. CPC G06T 1/20; G09G 2354/00; G06F 3/015; G09G 5/363

(57) ABSTRACT

An embodiment of a semiconductor package apparatus may include technology to determine user-related concentration information, and adjust one or more parameters of a graphics subsystem based on the user-related concentration information. Other embodiments are disclosed and claimed.

### TECHNICAL FIELD

Embodiments generally relate to graphics systems. More particularly, embodiments relate to concentration based adaptive graphics quality.

### BACKGROUND

Parallel graphics data processing may include technology to perform specific operations on graphics data such as, for example, linear interpolation, tessellation, rasterization, texture mapping, depth testing, etc. Some graphics processors may use fixed function computational units to process graphics data. Portions of some graphics processors may be programmable, enabling such processors to support a wider variety of operations for processing vertex and fragment data. Various parameters may be applied to operations on graphics data which may affect quality of the graphics.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a semiconductor package apparatus according to an embodiment;

FIGS. 3A to 3C are flowcharts of an example of a method of adjusting a graphics parameter according to an embodiment;

FIG. 4 is a block diagram of an example of a graphics apparatus according to an embodiment;

FIG. 5 is a block diagram of another example of a graphics apparatus according to an embodiment;

FIGS. 6A and 6B are illustrative diagrams of an example of a head mounted display (HMD) according to an embodiment;

FIG. 7 is a block diagram of an example of a graphics system according to an embodiment;

FIG. 8 flowchart of an example of a method of adaptively adjusting quality based on concentration according to an embodiment;

FIG. 9 illustrates a graphics processing pipeline, according to an embodiment;

FIG. 10 is a block diagram of an example of a system having a navigation controller according to an embodiment;

FIG. 11 is a block diagram of an example of a system having a small form factor according to an embodiment.

FIG. 12 is an illustration of an example of a HMD system according to an embodiment;

FIG. 13 is a block diagram of an example of the functional components included in the HMD system of FIG. 12 according to an embodiment; and

FIG. 14 is a block diagram of an example of a cloud-assisted media delivery architecture according to an embodiment.

### DESCRIPTION OF EMBODIMENTS

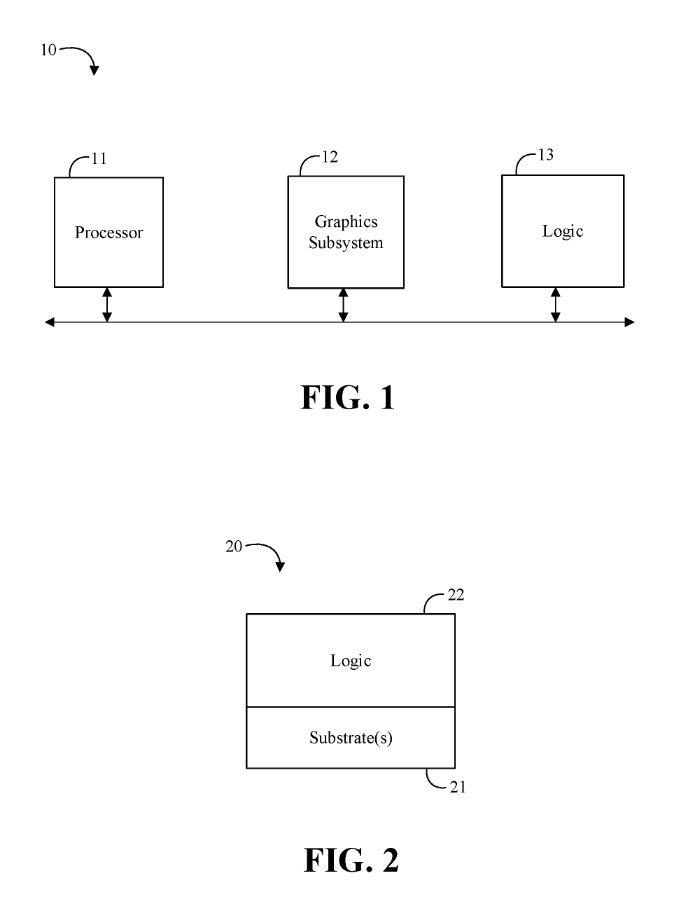

Turning now to FIG. 1, an embodiment of an electronic processing system 10 may include a processor 11, a graphics subsystem 12 communicatively coupled to the processor 11, and logic 13 communicatively coupled to the processor 11 to determine user-related concentration information, and adjust one or more parameters of the graphics subsystem 12 based on the user-related concentration information. For example, the logic 13 may be configured to determine the user-related concentration information based on measured electroencephalograph (EEG) information. In some embodiments, the logic 13 may be configured to adjust the one or more parameters to adjust a render quality of the graphics subsystem 12 based on the user-related concentration information, and/or to adjust the one or more parameters to adjust one or more of an encode and a decode quality of the graphics subsystem 12 based on the user-related concentration information. For example, the logic 13 may be configured to determine an increase in a level of concentration, and adjust the one or more parameters to increase one or more of a bandwidth, a resolution, and a frame rate of the graphics subsystem based on the increased level of concentration. In some embodiments, the graphics subsystem 12 may include at least one of a render pipeline, an encode pipeline, and a decode pipeline for stereo VR content.

A complex graphics system may include numerous parameters which may be relevant to quality, power, performance, etc. For example, higher level parameters may correspond to one or more settings such as a quality setting, a power setting, a performance setting, a network setting, etc. Higher level parameters may also correspond to one or more modes such as a high performance mode, a balanced performance mode, a low power mode, a high bandwidth mode, a game mode, a movie mode, etc. Lower level parameters may correspond to graphics quality such as resolution, frame rate, color precision, sampling rate, polygon model complexity, etc. Lower level parameters may also include graphics processor unit (GPU) parameters such as sleep time for a GPU unit, wake time for a GPU unit, GPU frequency, ring frequency, CPU frequency, memory frequency, cache configuration, dispatch width, resource cacheability settings, compiler optimization settings (e.g. loop unrolling preferences, etc.), thread group walk order for compute shaders, shading frequency, enabling or disabling hardware features, and power configuration/state (e.g. for various parts of the GPU such as slices, subslices, compute engines, etc.). The foregoing example parameters should be considered as illustrative and not limiting of parameters that may be adjusted based on the user-related concentration information in accordance with some embodiments.

Embodiments of each of the above processor 11, graphics subsystem 12, logic 13, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the system 10 may further include persistent storage media or other system memory to store a set of instructions which when executed by the processor 11 cause the system 10 to implement one or more components, features, or aspects of the system 10 (e.g., the logic 13, determining user-related concentration information for the graphics subsystem, adjusting one or more parameters of the graphics subsystem based on the user-related concentration information, etc.).

Turning now to FIG. 2, an embodiment of a semiconductor package apparatus 20 may include one or more substrates 21, and logic 22 coupled to the one or more substrates 21, wherein the logic 22 is at least partly implemented in one or more of configurable logic and fixed-functionality hardware logic. The logic 22 coupled to the one or more substrates may be configured to determine user-related concentration information, and adjust one or more parameters of a graphics subsystem based on the user-related concentration information. For example, the logic 22 may be configured to determine the user-related concentration information based on measured EEG information. In some embodiments, the logic 22 may be configured to adjust the one or more parameters to adjust a render quality of the graphics subsystem based on the user-related concentration information, and/or to adjust the one or more parameters to adjust one or more of an encode and a decode quality of the graphics subsystem based on the user-related concentration information. For example, the logic 22 may be configured to determine an increase in a level of concentration, and adjust the one or more parameters to increase one or more of a bandwidth, a resolution, and a frame rate of the graphics subsystem based on the increased level of concentration. In some embodiments, the graphics subsystem may include at least one of a render pipeline, an encode pipeline, and a decode pipeline for stereo VR content.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

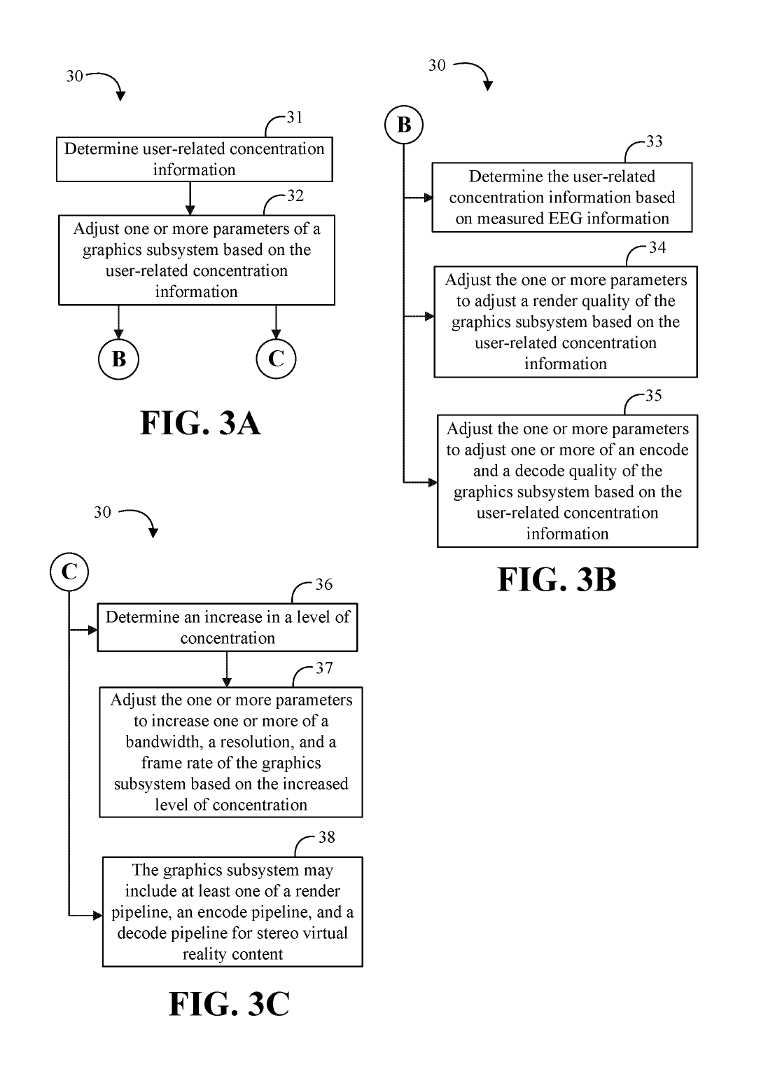

Turning now to FIGS. 3A to 3C, an embodiment of a method 30 of adjusting a graphics parameter may include determining user-related concentration information at block 31, and adjusting one or more parameters of a graphics subsystem based on the user-related concentration information at block 32. For example, the method 30 may include determining the user-related concentration information based on measured EEG information at block 33. Some embodiments of the method 30 may also include adjusting the one or more parameters to adjust a render quality of the graphics subsystem based on the user-related concentration information at block 34, and/or adjusting the one or more parameters to adjust one or more of an encode and a decode quality of the graphics subsystem based on the user-related concentration information at block 35. For example, the method 30 may include determining an increase in a level of concentration at block 36, and adjusting the one or more parameters to increase one or more of a bandwidth, a resolution, and a frame rate of the graphics subsystem based on the increased level of concentration at block 37. In some embodiments, the graphics subsystem may include at least one of a render pipeline, an encode pipeline, and a decode pipeline for stereo virtual reality content at block 38.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 30 may be implemented on a computer readable medium as described in connection with Examples 19 to 24 below. Embodiments or portions of the method 30 may be implemented in applications (e.g., through an application programming interface (API)) or driver software running on an operating system (OS).

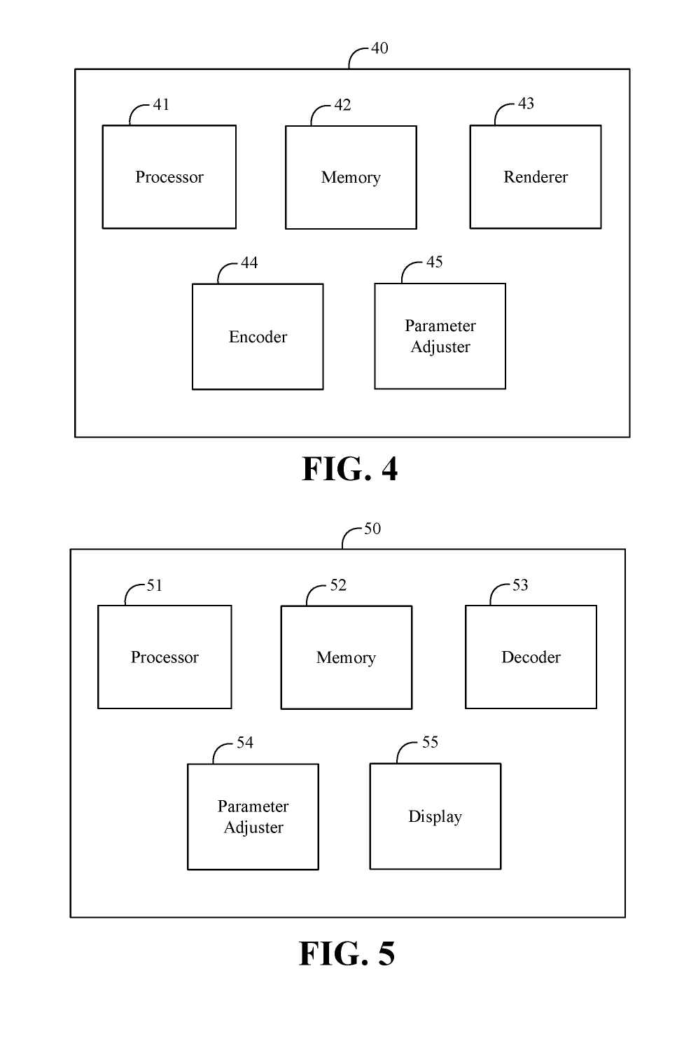

Turning now to FIG. 4, an embodiment of a graphics apparatus 40 may include a processor 41, memory 42, a renderer 43, an encoder 44, and a parameter adjuster 45. The parameter adjuster 45 may include technology to determine user-related concentration information, and to adjust one or more parameters of the graphics apparatus 40 based on the user-related concentration information. For example, the parameter adjuster 45 may be configured to determine the user-related concentration information based on measured EEG information. In some embodiments, the parameter adjuster 45 may be configured to adjust the one or more parameters to adjust a render quality of the renderer 43 based on the user-related concentration information, and/or to adjust the one or more parameters to adjust an encode quality of the encoder 44 based on the user-related concentration information. The encoded information may be provided to a user device such as a HMD. For example, the parameter adjuster 45 may be configured to determine an increase in a level of concentration, and adjust the one or more parameters to increase one or more of a bandwidth, a resolution, and a frame rate of the graphics apparatus 40 based on the increased level of concentration. For example, the renderer 43 may include a stereo VR render pipeline. For example, the encoder 44 may include a stereo VR encode pipeline (e.g., a three-dimension (3D) pipeline and/or a media pipeline).

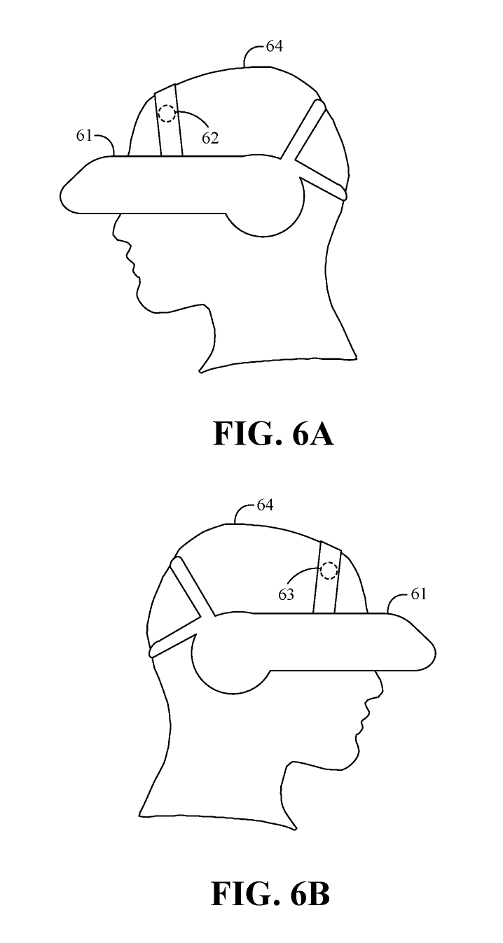

Turning now to FIG. 5, an embodiment of a graphics apparatus 50 may include a processor 51, memory 52, a decoder 53, a parameter adjuster 54, and a display 55. The parameter adjuster 54 may include technology to determine user-related concentration information, and to adjust one or more parameters of the graphics apparatus 50 based on the user-related concentration information. For example, the parameter adjuster 54 may be configured to determine the user-related concentration information based on measured EEG information. In some embodiments, the parameter adjuster 54 may be configured to adjust the one or more parameters to adjust a decode quality of the decoder 53 based on the user-related concentration information. The decoded information may be provided to the display 55. For example, the parameter adjuster 54 may be configured to determine an increase in a level of concentration, and adjust the one or more parameters to increase one or more of a bandwidth, a resolution, and a frame rate of the graphics apparatus 50 based on the increased level of concentration. For example, the decoder 53 may include a stereo VR decode pipeline.

Some embodiments may advantageously provide concentration based adaptive audio and/or video (AV) quality for HMDs. Any suitable technology may be utilized to provide the concentration information. For example, brain-computer interface (BCI) technology may sense brain or neuronal activity and provide signals suitable for use by a computer system. Based on gathered temporal and spatial patterns of biophysical signals, a concentration sensor may measure and identify a level of concentration of a person. For example, temporal and spatial patterns of biophysical signals may be obtained through, but not limited to, electrical, fluidic, chemical, and/or magnetic sensors.

Examples of devices that gather electrical signals include EEG. EEG may use electrodes placed directly on the scalp to measure electrical potentials generated by activity in the brain. Devices that measure and sense fluidic signals include Doppler ultrasound and devices that measure chemical signals include functional near-infrared spectroscopy (fNIRS). Doppler ultrasound measures cerebral blood flow velocity (CBFV) in the network of arteries that supply the brain. Cognitive activation produces increases in CBFV within these arteries that may be detected using Doppler ultrasound. fNIRS technology works by projecting near infrared light into the brain from the surface of the scalp and measuring optical changes at various wavelengths as the light is refracted and reflected back to the surface. The fNIRS effectively measures cerebral hemodynamics and detects localized blood volume and oxygenation changes. Since changes in tissue oxygenation associated with brain activity modulate the absorption and scattering of the near infrared light photons to varying amounts, fNIRS may be used to build functional maps of brain activity. Devices that measure magnetic signals include magnetoencephalography (MEG). A MEG measures magnetic fields generated by the electrical activity of the brain. MEG enables much deeper imaging and is much more sensitive than EEG because the skull is substantially transparent to magnetic waves.

Neuroimaging devices that measure the resulting brain activation patterns may include EEG, fNIRS, MEG, MRI (magnetic resonance imaging), ultrasound, etc. Commercial products such as the NEUROSKY THINKGEAR ASIC module and/or MINDWAVE headsets may include suitable sensor technology for measuring a user's level of concentration. However, embodiments are not limited to measurement systems specifically mentioned herein. Through the use of biophysical sensor devices, as described herein and others, a measured level of concentration of a person may be provided to an embodiment of a graphics system, and the graphics system may adjust the quality of the graphics processing based on the provided concentration information.

Turning now to FIGS. 6A to 6B, an embodiment of a HMD 61 may include one or more EEG sensors 62, 63 for measuring concentration according to an embodiment. The EEG sensors 62, 63 may be held in place against the head 64 of a user with any suitable structure, including adhesive, an elastic headband, the housing of the HMD 61 (e.g., embedded in padding material, repositionable with VELCRO), etc. Measurement and analysis of EEG signals using the EEG sensors 62, 63 placed at various location on the head 64 may be used to determine a level of concentration for the user. The HMD 61 may provide a suitable form factor where EEG electrodes may be used without negatively affecting the user experience. For example, the EEG sensors 62, 63 may be incorporated in the housing and/or support bands of the HMD 61 such that no additional action is required by the user to appropriately place the sensors (e.g., except for some initial positioning). Advantageously, some embodiments may utilize brain functions such as concentration to increase or decrease the quality of the AV content to provide a better experience to the user.

Some applications may use a large number of electrodes (e.g., up to 25 electrodes) for EEG analysis. However, a smaller subset of electrodes may be used to determine level of concentration (e.g., 3 electrodes or less in some embodiments). In some embodiments, the two EEG sensors 62, 63 may be positioned to measure frontal lobe brain activity. For example, the positioning of the EEG sensors 62, 63 may follow the international 10-20 system for EEG electrodes with the EEG sensor 62 at frontal polar position Fp1 and the EEG sensor 63 at frontal polar position Fp2. The frontal polar electrodes Fp1 and Fp2 may provide suitable indicators for concentration levels. When viewing VR content, for example, the user may be immersed in the content experience with varied levels of concentration detected by the EEG sensors 62, 63. Advantageously, some embodiments may detect heightened levels of concentration to trigger improved AV quality (e.g., while maintaining or reducing quality at decreased levels of concentration).

Some other systems may provide quality adaptation triggers such as network conditions, distance, other biometrics, pupil location and size to determine affinity to and type of content. Concentration may be quantitatively different from other biometrics such as emotional state, affinity to content, engagement, etc. (e.g., especially with respect to measured brain activity). Some embodiments may advantageously provide concentration level adaptive quality which may be important from a user experience perspective, because concentration on content is different from having an affinity to the content, emotional state, engagement, etc. For example, subjective quality may vary based on the user's level of concentration. In particular, distortion in an area of a scene may have a stronger influence on subjective quality if the viewer is specifically concentrating on that area of the scene. Some embodiments may advantageously adjust the quality (bitrate, etc.) based on whether the user is concentrating (e.g., or not) to maintain a subjective level of quality. Some embodiments may be advantageously combined with foveated techniques or other adaptive techniques to provide an even better user experience.

For example, some embodiments may analyze EEG signals to determine increased levels of concentration. Increased levels of concentration may be an indicator that the user is interested in the VR content in which the user is currently immersed. When increased concentration is determined, some embodiments may increase the quality of the rendered AV content. Advantageously, some embodiments may make better or more appropriate use of memory, compute, power, and/or network resources. For example, bandwidth may be an important consideration to get video/images to an HMD over a network (e.g., wireless PAN, LAN, and/or larger networks) for a wide variety of use cases including education, medicine, various consumer usages, VR enterprise usages such as remote document sharing, etc. Advantageously, some embodiments may improve or optimize delivery of data to the HMD with improved or best relevant quality.

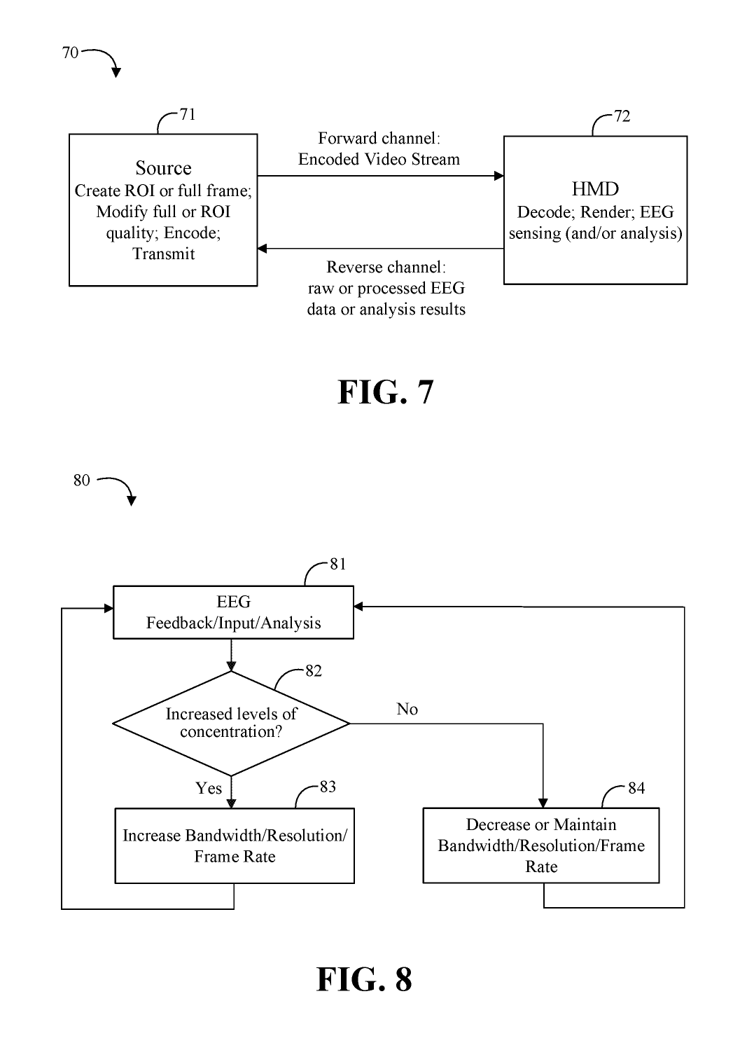

Turning now to FIG. 7, an embodiment of a graphics system 70 may include a source 71 communicatively coupled to a HMD 72 (e.g., wirelessly, or wired via, for example, USB). The source 71 may create a region of interest (ROI) image or a full frame image from source content, modify the ROI or full frame image based on user-related concentration information, encode the image, and transmit the image to the HMD 72. The HMD 72 may decode the received image, render the image as needed following the decode, and display the image on one or more display panels of the HMD 72. The HMD 72 may provide EEG sensing and/or analysis. The HMD 72 may provide raw of processed EEG data or analysis results to the source 71 over a reverse communication channel for feedback to the source 71 from the HMD 72. The HMD 72 may also modify the decode, local render, and/or display of the image based on the user-related concentration information from the EEG sensing/analysis.

For the system 70 where source encoding may be performed, some embodiments may advantageously increase the bandwidth and the quality of the audio-video stream when the source 71 detects that the user may be concentrating on the content (e.g., using the results of the analysis from the EEG sensors on the HMD 72). Bandwidth savings may be obtained otherwise when the source 71 detects that the user is not concentrating on the content. Whether or not source encoding is performed, some embodiments may also use detected concentration as a trigger to modify resolution and/or other factors that may reduce processing and power consumption on one or both of the source 71 and the HMD 72. For example, the content may include VR content, augmented reality (AR) content, merged reality (MR) content, 3D content, 360 video content, FreeD content, etc.

Turning now to FIG. 8, an embodiment of a method 80 of adaptively adjusting quality based on concentration may include providing EEG feedback/input/analysis at block 81 and determining if the level of concentration increased at block 82 (e.g., by comparing a current level of concentration against a prior level of concentration). If there is an increased level of concentration at block 82, the method 80 may increase one or more of bandwidth, resolution, and frame rate for a graphics system at block 83. Otherwise, the method may decrease or maintain the bandwidth, resolution, and/or frame rate for a graphics system at block 84. For example, if the current level of concentration is greater than the prior level of concentration by at least a first threshold value, the parameters of the graphics system may be adjusted to increase one or more of the bandwidth, resolution, and frame rate. If the current level of concentration is lower than the prior level of concentration by at least a second threshold value, the parameters may be adjusted to reduce one or more of the bandwidth, resolution, and frame rate. Otherwise, the current parameters of the graphics system may not be adjusted based on the concentration information. The method 80 of adaptive quality based on concentration via EEG analysis may be combined with ROI/foveated and/or other adaptive forms of rendering.

Some embodiments may not necessarily decrease quality based on detected low concentration. Instead, some embodiments may maintain normal quality levels for low concentration (e.g., enough quality for a good low concentration experience, particularly for a bandwidth/resource constrained system). When the user concentrates, the user may be paying more attention and accordingly the probability of noticing issues with content may be higher. Higher concentration may also imply that the expectations of the user on the quality of the content may be higher. When higher concentration is detected, some embodiments may increase the quality levels for a better user experience. For systems where bandwidth and execution cycles may be a consideration, adaptive modification of the quality based on concentration may provide more effective utilization of the resources. Instead of streaming at high quality all the time, some embodiments may only stream high quality when higher concentration is detected and may stream only reasonably good quality at other times. For example, during periods of low concentration such as quick browsing, skimming through content, etc., some embodiments may stream 4K video at 10-15 Mbps. During periods of high concentration, some embodiments may stream 4K video at 20 Mbps.

Graphics Processing Pipeline Example

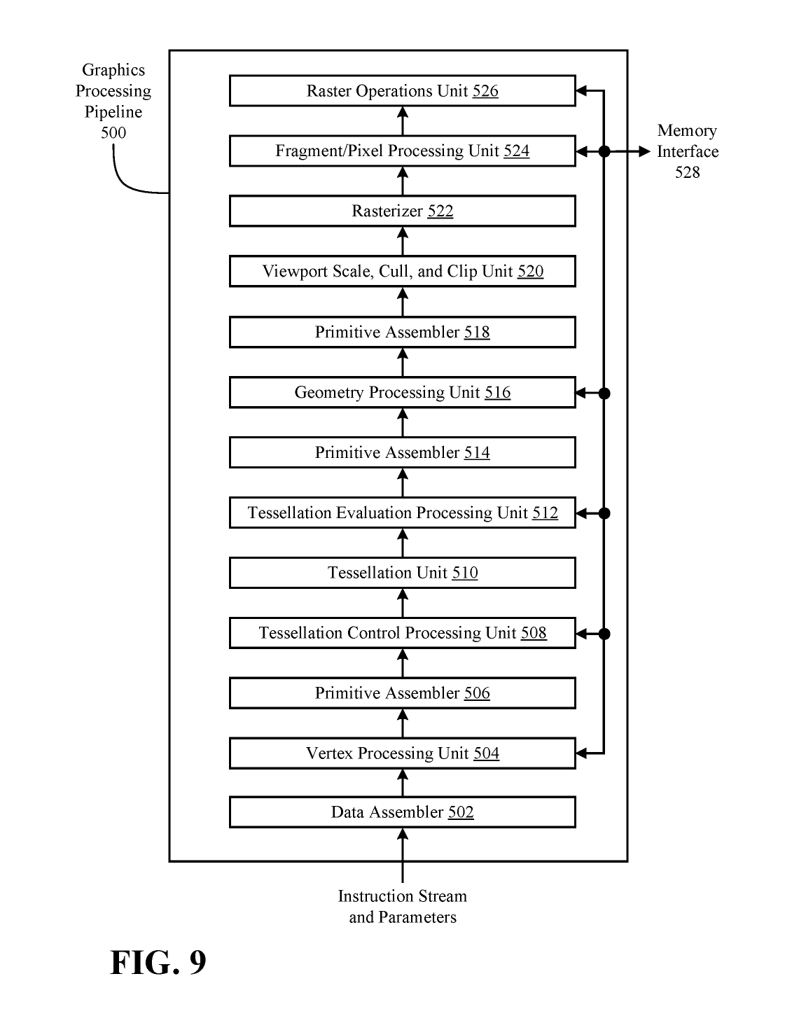

FIG. 9 illustrates a graphics processing pipeline 500, according to an embodiment. In some embodiments, a graphics processor or GPU may implement the illustrated graphics processing pipeline 500. The graphics processor may be included within a parallel processing subsystem. For example, a programmable shader unit may be configured to perform the functions of one or more of a vertex processing unit 504, a tessellation control processing unit 508, a tessellation evaluation processing unit 512, a geometry processing unit 516, and a fragment/pixel processing unit 524. The functions of data assembler 502, primitive assemblers 506, 514, 518, tessellation unit 510, rasterizer 522, and raster operations unit 526 may also be performed by other processing engines within a processing cluster and a corresponding partition unit. The graphics processing pipeline 500 may also be implemented using dedicated processing units for one or more functions. In some embodiments, one or more portions of the graphics processing pipeline 500 can be performed by parallel processing logic within a general purpose processor (e.g., CPU). In some embodiments, one or more portions of the graphics processing pipeline 500 may access on-chip memory via a memory interface 528.

In some embodiments, the data assembler 502 may be a processing unit that collects vertex data for surfaces and primitives. The data assembler 502 then outputs the vertex data, including the vertex attributes, to the vertex processing unit 504. The vertex processing unit 504 is a programmable execution unit that executes vertex shader programs, lighting and transforming vertex data as specified by the vertex shader programs. The vertex processing unit 504 reads data that is stored in cache, local or system memory for use in processing the vertex data and may be programmed to transform the vertex data from an object-based coordinate representation to a world space coordinate space or a normalized device coordinate space.

A first instance of a primitive assembler 506 receives vertex attributes from the vertex processing unit 504. The primitive assembler 506 readings stored vertex attributes as needed and constructs graphics primitives for processing by tessellation control processing unit 508. The graphics primitives include triangles, line segments, points, patches, and so forth, as supported by various graphics processing application programming interfaces (APIs).

The tessellation control processing unit 508 treats the input vertices as control points for a geometric patch. The control points are transformed from an input representation from the patch (e.g., the patch's bases) to a representation that is suitable for use in surface evaluation by the tessellation evaluation processing unit 512. The tessellation control processing unit 508 can also compute tessellation factors for edges of geometric patches. A tessellation factor applies to a single edge and quantifies a view-dependent level of detail associated with the edge. A tessellation unit 510 is configured to receive the tessellation factors for edges of a patch and to tessellate the patch into multiple geometric primitives such as line, triangle, or quadrilateral primitives, which are transmitted to a tessellation evaluation processing unit 512. The tessellation evaluation processing unit 512 operates on parameterized coordinates of the subdivided patch to generate a surface representation and vertex attributes for each vertex associated with the geometric primitives.

A second instance of a primitive assembler 514 receives vertex attributes from the tessellation evaluation processing unit 512, reading stored vertex attributes as needed, and constructs graphics primitives for processing by the geometry processing unit 516. The geometry processing unit 516 is a programmable execution unit that executes geometry shader programs to transform graphics primitives received from primitive assembler 514 as specified by the geometry shader programs. In some embodiments, the geometry processing unit 516 is programmed to subdivide the graphics primitives into one or more new graphics primitives and calculate parameters used to rasterize the new graphics primitives.

In some embodiments, the geometry processing unit 516 can add or delete elements in the geometry stream. The geometry processing unit 516 outputs the parameters and vertices specifying new graphics primitives to primitive assembler 518. The primitive assembler 518 receives the parameters and vertices from the geometry processing unit 516 and constructs graphics primitives for processing by a viewport scale, cull, and clip unit 520. The geometry processing unit 516 reads data that is stored in parallel processor memory or system memory for use in processing the geometry data. The viewport scale, cull, and clip unit 520 performs clipping, culling, and viewport scaling and outputs processed graphics primitives to a rasterizer 522.

The rasterizer 522 can perform depth culling and other depth-based optimizations. The rasterizer 522 also performs scan conversion on the new graphics primitives to generate fragments and output those fragments and associated coverage data to the fragment/pixel processing unit 524. The fragment/pixel processing unit 524 is a programmable execution unit that is configured to execute fragment shader programs or pixel shader programs. The fragment/pixel processing unit 524 transforming fragments or pixels received from rasterizer 522, as specified by the fragment or pixel shader programs. For example, the fragment/pixel processing unit 524 may be programmed to perform operations included but not limited to texture mapping, shading, blending, texture correction and perspective correction to produce shaded fragments or pixels that are output to a raster operations unit 526. The fragment/pixel processing unit 524 can read data that is stored in either the parallel processor memory or the system memory for use when processing the fragment data. Fragment or pixel shader programs may be configured to shade at sample, pixel, tile, or other granularities depending on the sampling rate configured for the processing units.

The raster operations unit 526 is a processing unit that performs raster operations including, but not limited to stencil, z test, blending, and the like, and outputs pixel data as processed graphics data to be stored in graphics memory (e.g., parallel processor memory 222 as in FIG. 2, and/or system memory 104 as in FIG. 1, to be displayed on the one or more display device(s) 110 or for further processing by one of the one or more processor(s) 102 or parallel processor(s) 112. In some embodiments, the raster operations unit 526 is configured to compress z or color data that is written to memory and decompress z or color data that is read from memory.

One or more of the data assembler 502, vertex processing unit 504, primitive assembler 506, tessellation control processing unit 508, tessellation unit 510, tessellation evaluation processing unit 512, primitive assembler 514, geometry processing unit 516, primitive assembler 518, viewport scale, cull, and clip unit 520, rasterizer 522, fragment/pixel processing unit 524, and raster operations unit 526 may have configurable parameters which may affect their respective operation and/or the graphics quality. In accordance with some embodiments, a parameter adjuster may adjust one or more of these configurable parameters based on user-related concentration information.

Navigation Features Examples

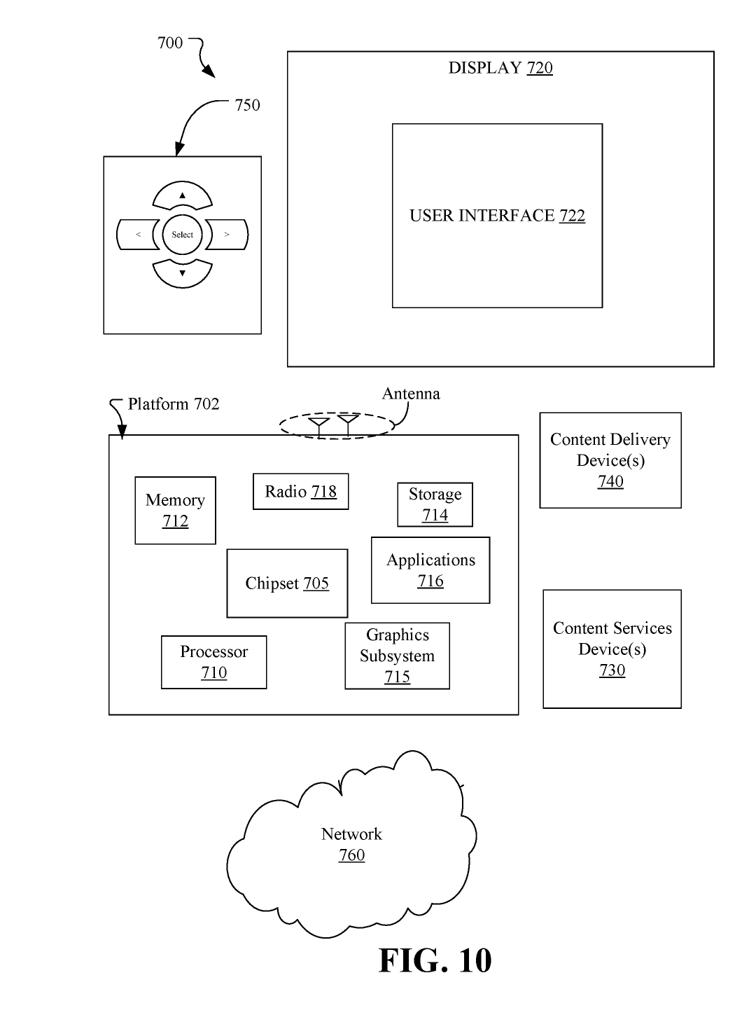

FIG. 10 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, the system 700 comprises a platform 702 coupled to a display 720 that presents visual content. The platform 702 may receive video bitstream content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, the platform 702 may comprise any combination of a chipset 705, processor 710, memory 712, storage 714, graphics subsystem 715, applications 716 and/or radio 718 (e.g., network controller). The chipset 705 may provide intercommunication among the processor 710, memory 712, storage 714, graphics subsystem 715, applications 716 and/or radio 718. For example, the chipset 705 may include a storage adapter (not depicted) capable of providing intercommunication with the storage 714.

The processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, the processor 710 may comprise dual-core processor(s), dual-core mobile processor(s), and so forth.

The memory 712 may be implemented as a volatile memory device such as, but not limited to, a Random Access Memory (RAM), Dynamic Random Access Memory (DRAM), or Static RAM (SRAM).

The storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

The graphics subsystem 715 may perform processing of images such as still or video for display. The graphics subsystem 715 may be a graphics processing unit (GPU) or a visual processing unit (VPU), for example. An analog or digital interface may be used to communicatively couple the graphics subsystem 715 and display 720. For example, the interface may be any of a High-Definition Multimedia Interface (HDMI), DisplayPort, wireless HDMI, and/or wireless HD compliant techniques. The graphics subsystem 715 could be integrated into processor 710 or chipset 705. The graphics subsystem 715 could be a stand-alone card communicatively coupled to the chipset 705. In one example, the graphics subsystem 715 includes a noise reduction subsystem as described herein.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 718 may be a network controller including one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, the display 720 may comprise any television type monitor or display. The display 720 may comprise, for example, a computer display screen, touch screen display, video monitor, television-like device, and/or a television. The display 720 may be digital and/or analog. In embodiments, the display 720 may be a holographic display. Also, the display 720 may be a transparent surface that may receive a visual projection. Such projections may convey various forms of information, images, and/or objects. For example, such projections may be a visual overlay for a mobile augmented reality (MAR) application. Under the control of one or more software applications 716, the platform 702 may display user interface 722 on the display 720.

In embodiments, content services device(s) 730 may be hosted by any national, international and/or independent service and thus accessible to the platform 702 via the Internet, for example. The content services device(s) 730 may be coupled to the platform 702 and/or to the display 720. The platform 702 and/or content services device(s) 730 may be coupled to a network 760 to communicate (e.g., send and/or receive) media information to and from network 760. The content delivery device(s) 740 also may be coupled to the platform 702 and/or to the display 720.

In embodiments, the content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

The content services device(s) 730 receives content such as cable television programming including media information, digital information, and/or other content. Examples of content providers may include any cable or satellite television or radio or Internet content providers. The provided examples are not meant to limit embodiments.

In embodiments, the platform 702 may receive control signals from a navigation controller 750 having one or more navigation features. The navigation features of the controller 750 may be used to interact with the user interface 722, for example. In embodiments, the navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of the controller 750 may be echoed on a display (e.g., display 720) by movements of a pointer, cursor, focus ring, or other visual indicators displayed on the display. For example, under the control of software applications 716, the navigation features located on the navigation controller 750 may be mapped to virtual navigation features displayed on the user interface 722, for example. In embodiments, the controller 750 may not be a separate component but integrated into the platform 702 and/or the display 720. Embodiments, however, are not limited to the elements or in the context shown or described herein.

In embodiments, drivers (not shown) may comprise technology to enable users to instantly turn on and off the platform 702 like a television with the touch of a button after initial boot-up, when enabled, for example. Program logic may allow the platform 702 to stream content to media adaptors or other content services device(s) 730 or content delivery device(s) 740 when the platform is turned “off.” In addition, chipset 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in the system 700 may be integrated. For example, the platform 702 and the content services device(s) 730 may be integrated, or the platform 702 and the content delivery device(s) 740 may be integrated, or the platform 702, the content services device(s) 730, and the content delivery device(s) 740 may be integrated, for example. In various embodiments, the platform 702 and the display 720 may be an integrated unit. The display 720 and content service device(s) 730 may be integrated, or the display 720 and the content delivery device(s) 740 may be integrated, for example. These examples are not meant to limit the embodiments.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

The platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 10.

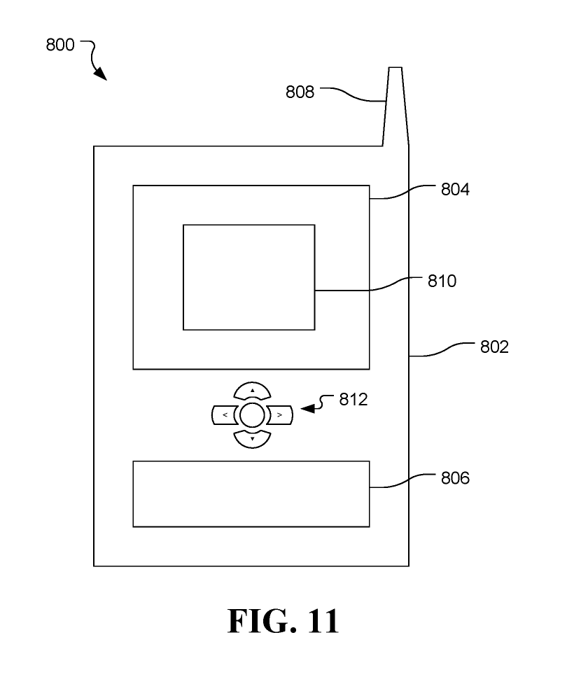

As described above, the system 700 may be embodied in varying physical styles or form factors. FIG. 11 illustrates embodiments of a small form factor device 800 in which the system 700 may be embodied. In embodiments, for example, the device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 11, the device 800 may comprise a housing 802, a display 804, an input/output (I/O) device 806, and an antenna 808. The device 800 also may comprise navigation features 812. The display 804 may comprise any suitable display unit for displaying information appropriate for a mobile computing device. The I/O device 806 may comprise any suitable I/O device for entering information into a mobile computing device. Examples for the I/O device 806 may include an alphanumeric keyboard, a numeric keypad, a touch pad, input keys, buttons, switches, rocker switches, microphones, speakers, voice recognition device and software, and so forth. Information also may be entered into the device 800 by way of microphone. Such information may be digitized by a voice recognition device. The embodiments are not limited in this context.

In some embodiments, the system 700 and/or the device 800 may include a wired or wireless interface to a user's brain activity monitor (e.g., a headset including one or more EEG sensors worn by a user) and may be further configured to adjust one or more parameters of the system 700 and/or device 800 based on user-related concentration information. In particular, the system 700 and/or device 800 may implement one or more aspects of the below Additional Notes and Examples.

Head-Mounted Integrated Interface System Example

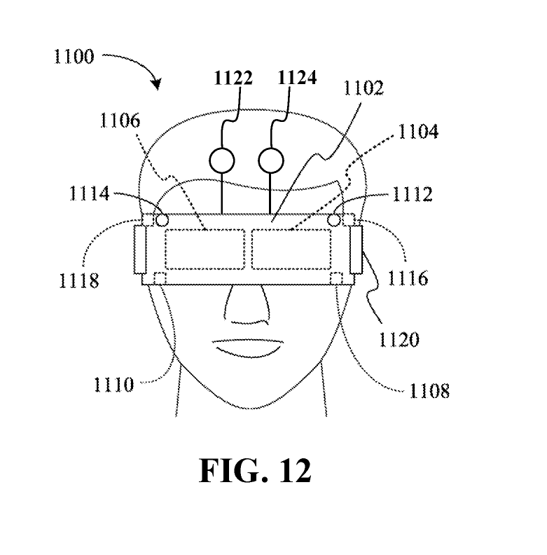

FIG. 12 shows a head mounted display (HMD) system 1100 that is being worn by a user while experiencing an immersive environment such as, for example, a virtual reality (VR) environment, an augmented reality (AR) environment, a multi-player three-dimensional (3D) game, and so forth. In the illustrated example, one or more straps 1120 hold a frame 1102 of the HMD system 1100 in front of the eyes of the user. Accordingly, a left-eye display 1104 may be positioned to be viewed by the left eye of the user and a right-eye display 1106 may be positioned to be viewed by the right eye of the user. The left-eye display 1104 and the right-eye display 1106 may alternatively be integrated into a single display in certain examples such as, for example, a smart phone being worn by the user. In the case of AR, the displays 1104, 1106 may be view-through displays that permit the user to view the physical surroundings, with other rendered content (e.g., virtual characters, informational annotations, heads up display/HUD) being presented on top a live feed of the physical surroundings.

In one example, the frame 1102 includes a left look-down camera 1108 to capture images from an area generally in front of the user and beneath the left eye (e.g., left hand gestures). Additionally, a right look-down camera 1110 may capture images from an area generally in front of the user and beneath the right eye (e.g., right hand gestures). The illustrated frame 1102 also includes a left look-front camera 1112 and a right look-front camera 1114 to capture images in front of the left and right eyes, respectively, of the user. The frame 1102 may also include a left look-side camera 1116 to capture images from an area to the left of the user and a right look-side camera 1118 to capture images from an area to the right of the user.

The images captured by the cameras 1108, 1110, 1112, 1114, 1116, 1118, which may have overlapping fields of view, may be used to detect gestures made by the user as well as to analyze and/or reproduce the external environment on the displays 1104, 1106. In one example, the detected gestures are used by a graphics processing architecture (e.g., internal and/or external) to render and/or control a virtual representation of the user in a 3D game. Indeed, the overlapping fields of view may enable the capture of gestures made by other individuals (e.g., in a multi-player game), where the gestures of other individuals may be further used to render/control the immersive experience. The overlapping fields of view may also enable the HMD system 1100 to automatically detect obstructions or other hazards near the user. Such an approach may be particularly advantageous in advanced driver assistance system (ADAS) applications.

In one example, providing the left look-down camera 1108 and the right look-down camera 1110 with overlapping fields of view provides a stereoscopic view having an increased resolution. The increased resolution may in turn enable very similar user movements to be distinguished from one another (e.g., at sub-millimeter accuracy). The result may be an enhanced performance of the HMD system 1100 with respect to reliability. Indeed, the illustrated solution may be useful in a wide variety of applications such as, for example, coloring information in AR settings, exchanging virtual tools/devices between users in a multi-user environment, rendering virtual items (e.g., weapons, swords, staffs), and so forth. Gestures of other objects, limbs and/or body parts may also be detected and used to render/control the virtual environment. For example, myelographic signals, electroencephalographic signals, eye tracking, breathing or puffing, hand motions, etc., may be tracked in real-time, whether from the wearer or another individual in a shared environment. The images captured by the cameras 1108, 1110, 1112, 1114, 1116, 1118, may also serve as contextual input. For example, it might be determined that the user is indicating a particular word to edit or key to press in a word processing application, a particular weapon to deployed or a travel direction in a game, and so forth.

Additionally, the images captured by the cameras 1108, 1110, 1112, 1114, 1116, 1118, may be used to conduct shared communication or networked interactivity in equipment operation, medical training, and/or remote/tele-operation guidance applications. Task specific gesture libraries or neural network machine learning could enable tool identification and feedback for a task. For example, a virtual tool that translates into remote, real actions may be enabled. In yet another example, the HMD system 1100 translates the manipulation of a virtual drill within a virtual scene to the remote operation of a drill on a robotic device deployed to search a collapsed building. Moreover, the HMD system 1100 may be programmable to the extent that it includes, for example, a protocol that enables the user to add a new gesture to a list of identifiable gestures associated with user actions.

In addition, the various cameras in the HMD 1100 may be configurable to detect spectrum frequencies in addition to the visible wavelengths of the spectrum. Multi-spectral imaging capabilities in the input cameras allows position tracking of the user and/or objects by eliminating nonessential image features (e.g., background noise). For example, in augmented reality (AR) applications such as surgery, instruments and equipment may be tracked by their infrared reflectivity without the need for additional tracking aids. Moreover, HMD 1100 could be employed in situations of low visibility where a “live feed” from the various cameras could be enhanced or augmented through computer analysis and displayed to the user as visual or audio cues.

The HMD system 1100 may also forego performing any type of data communication with a remote computing system or need power cables (e.g., independent mode of operation). In this regard, the HMD system 1100 may be a “cordless” device having a power unit that enables the HMD system 1100 to operate independently of external power systems. Accordingly, the user might play a full featured game without being tethered to another device (e.g., game console) or power supply. In a word processing example, the HMD system 1100 might present a virtual keyboard and/or virtual mouse on the displays 1104 and 1106 to provide a virtual desktop or word processing scene. Thus, gesture recognition data captured by one or more of the cameras may represent user typing activities on the virtual keyboard or movements of the virtual mouse. Advantages include, but are not limited to, ease of portability and privacy of the virtual desktop from nearby individuals. The underlying graphics processing architecture may support compression and/or decompression of video and audio signals. Moreover, providing separate images to the left eye and right eye of the user may facilitate the rendering, generation and/or perception of 3D scenes. The relative positions of the left-eye display 1104 and the right-eye display 1106 may also be adjustable to match variations in eye separation between different users.

The number of cameras illustrated in FIG. 11 is to facilitate discussion only. Indeed, the HMD system 1100 may include less than six or more than six cameras, depending on the circumstances.

In some embodiments, the HMD system 1100 may further include one or more sensors 1122, 1124 coupled to the frame 1102 to monitor brain activity of the user related to concentration. The HMD system 1100 may be configured to adjust various parameters of the HMD system 1100 based on user-related concentration information derived from the sensors 1122, 1124. For example, the sensors 1122, 1124 may include EEG electrodes.

Functional Components of the HMD System

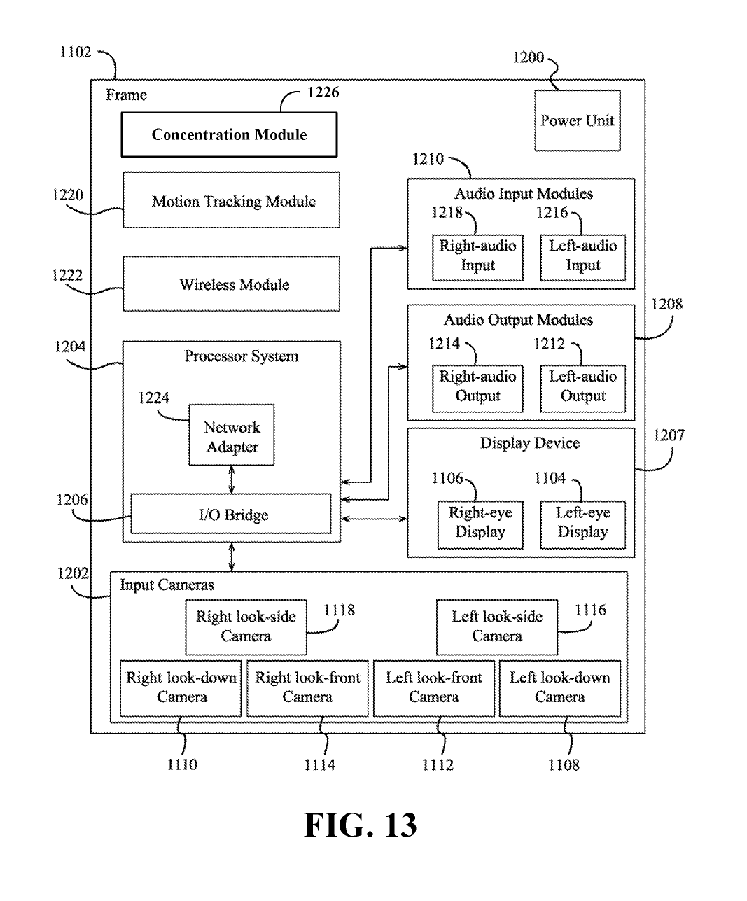

FIG. 13 shows the HMD system in greater detail. In the illustrated example, the frame 1102 includes a power unit 1200 (e.g., battery power, adapter) to provide power to the HMD system. The illustrated frame 1102 also includes a motion tracking module 1220 (e.g., accelerometers, gyroscopes), wherein the motion tracking module 1220 provides motion tracking data, orientation data and/or position data to a processor system 1204. The processor system 1204 may include a network adapter 1224 that is coupled to an I/O bridge 1206. The I/O bridge 1206 may enable communications between the network adapter 1224 and various components such as, for example, audio input modules 1210, audio output modules 1208, a display device 1207, input cameras 1202, and so forth.

In the illustrated example, the audio input modules 1210 include a right-audio input 1218 and a left-audio input 1216, which detect sound that may be processed in order to recognize voice commands of the user as well as nearby individuals. The voice commands recognized in the captured audio signals may augment gesture recognition during modality switching and other applications. Moreover, the captured audio signals may provide 3D information that is used to enhance the immersive experience.

The audio output modules 1208 may include a right-audio output 1214 and a left-audio output 1212. The audio output modules 1208 may deliver sound to the ears of the user and/or other nearby individuals. The audio output modules 1208, which may be in the form of earbuds, on-ear speakers, over the ear speakers, loudspeakers, etc., or any combination thereof, may deliver stereo and/or 3D audio content to the user (e.g., spatial localization). The illustrated frame 1102 also includes a wireless module 1222, which may facilitate communications between the HMD system and various other systems (e.g., computers, wearable devices, game consoles). In one example, the wireless module 1222 communicates with the processor system 1204 via the network adapter 1224.

The illustrated display device 1207 includes the left-eye display 1104 and the right-eye display 1106, wherein the visual content presented on the displays 1104, 1106 may be obtained from the processor system 1204 via the I/O bridge 1206. The input cameras 1202 may include the left look-side camera 1116 the right look-side camera 1118, the left look-down camera 1108, the left look-front camera 1112, the right look-front camera 1114 and the right look-down camera 1110, already discussed.

The illustrated frame 1102 may also include a concentration module 1226 coupled to the sensors 1122, 1124 to process information therefrom and determine a level of concentration of the user based on the processed information. For example, the processor system 1204 may include logic or a set of instructions which cause the processor system 1204 to communicate user-related concentration information to a connect source system. Additionally, or alternatively, the processor system 1204 may include logic or a set of instructions which cause the processor system 1204 to adjust the operation of one or more of the modules included in the frame 1102. For example, the processor system 1204 may adjust the operation of the input cameras 1202, the display device 1207, the audio modules 1208, 1210, the motion tracking module 1220, and/or the wireless module 1222 based on the user-related concentration information from the concentration module 1226. Some embodiments may increase both audio and video quality based on a detected higher level of concentration.

Cloud-Assisted Media Delivery

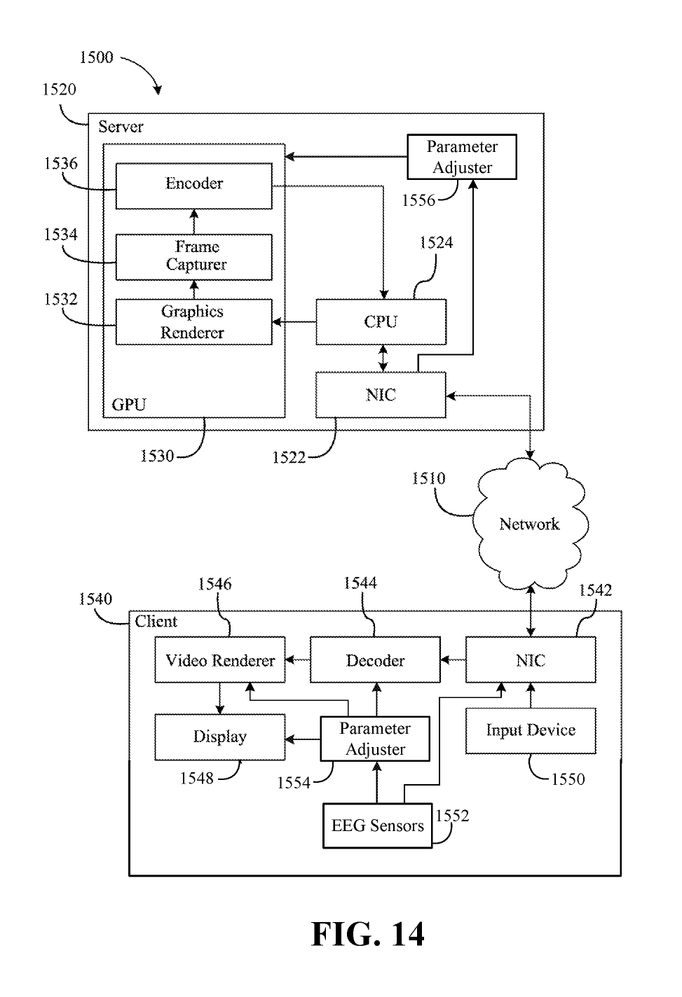

Turning now to FIG. 14, a cloud gaming system 1500 includes a client 1540 that is coupled to a server 1520 through a network 1510. The client 1540 may generally be a consumer of graphics (e.g., gaming, virtual reality/VR, augmented reality/AR) content that is housed, processed and rendered on the server 1520. The illustrated server 1520, which may be scalable, has the capacity to provide the graphics content to multiple clients simultaneously (e.g., by leveraging parallel and apportioned processing and rendering resources). In one example, the scalability of the server 1520 is limited by the capacity of the network 1510. Accordingly, there may be some threshold number of clients above which the service to all clients made degrade.

In one example, the server 1520 includes a graphics processor (e.g., GPU) 1530, a host processor (e.g., CPU) 1524 and a network interface card (NIC) 1522. The NIC 1522 may receive a request from the client 1540 for graphics content. The request from the client 1540 may cause the graphics content to be retrieved from memory via an application executing on the host processor 1524. The host processor 1524 may carry out high level operations such as, for example, determining position, collision and motion of objects in a given scene. Based on the high level operations, the host processor 1524 may generate rendering commands that are combined with the scene data and executed by the graphics processor 1530. The rendering commands may cause the graphics processor 1530 to define scene geometry, shading, lighting, motion, texturing, camera parameters, etc., for scenes to be presented via the client 1540.

More particularly, the illustrated graphics processor 1530 includes a graphics renderer 1532 that executes rendering procedures according to the rendering commands generated by the host processor 1524. The output of the graphics renderer 1532 may be a stream of raw video frames that are provided to a frame capturer 1534. The illustrated frame capturer 1534 is coupled to an encoder 1536, which may compress/format the raw video stream for transmission over the network 1510. The encoder 1536 may use a wide variety of video compression algorithms such as, for example, the H.264 standard from the International Telecommunication Union Telecommunication Standardization Sector (ITUT), the MPEG4 Advanced Video Coding (AVC) Standard from the International Organization for the Standardization/International Electrotechnical Commission (ISO/IEC), and so forth.

The illustrated client 1540, which may be a desktop computer, notebook computer, tablet computer, convertible tablet, wearable device, MID, PDA, media player, HMD, etc., includes a NIC 1542 to receive the transmitted video stream from the server 1520. The NIC 1522, may include the physical layer and the basis for the software layer of the network interface in the client 1540 in order to facilitate communications over the network 1510. The client 1540 may also include a decoder 1544 that employs the same formatting/compression scheme of the encoder 1536. Thus, the decompressed video stream may be provided from the decoder 1544 to a video renderer 1546. The illustrated video renderer 1546 is coupled to a display 1548 that visually presents the graphics content.

As already noted, the graphics content may include gaming content. In this regard, the client 1540 may conduct real-time interactive streaming that involves the collection of user input from an input device 1550 and delivery of the user input to the server 1520 via the network 1510. This real-time interactive component of cloud gaming may pose challenges with regard to latency.

In some embodiments, the client 1540 may include one or more sensors 1552, including brain activity sensors, and a parameter adjuster 1554 coupled to the sensors 1552 to adjust one or more parameters of the client 1540 based on information from the sensors 1552, including user-related concentration information. For example, the parameter adjuster 1554 may adjust the quality of one or more of the decoder 1544, the video renderer 1546, and the display 1548. The client 1540 may also adjust parameters of the NIC 1542 to increase the network bandwidth of the content on which the user is concentrating (e.g., by prioritizing that content in the NIC 1542). The client 1540 may also provide the user-related concentration information to the server 1520. The server 1520 may include a parameter adjuster 1556 coupled to the NIC 1522 which may adjust one or more parameters of the server 1520 based on the user-related concentration information. For example, the parameter adjuster 1556 may adjust the quality of one or more of the GPU 1530, the graphics renderer 1532, the frame capturer 1534, and the encoder 1536. The parameter adjuster 1556 may also adjust parameters of the NIC 1522 to increase the network bandwidth of the content on which the user is concentrating (e.g., by prioritizing that content in the NIC 1522).

### ADDITIONAL NOTES AND EXAMPLES

Example 1 may include an electronic processing system, comprising a processor, a graphics subsystem communicatively coupled to the processor, and logic communicatively coupled to the processor to determine user-related concentration information, and adjust one or more parameters of the graphics subsystem based on the user-related concentration information.

Example 2 may include the system of Example 1, wherein the logic is further to determine the user-related concentration information based on measured electroencephalograph information.

Example 3 may include the system of Example 1, wherein the logic is further to adjust the one or more parameters to adjust a render quality of the graphics subsystem based on the user-related concentration information.

Example 4 may include the system of Example 1, wherein the logic is further to adjust the one or more parameters to adjust one or more of an encode and a decode quality of the graphics subsystem based on the user-related concentration information.

Example 5 may include the system of Example 1, wherein the logic is further to determine an increase in a level of concentration, and adjust the one or more parameters to increase one or more of a bandwidth, a resolution, and a frame rate of the graphics subsystem based on the increased level of concentration.

Example 6 may include the system of any of Examples 1 to 5, wherein the graphics subsystem includes at least one of a render pipeline, an encode pipeline, and a decode pipeline for stereo virtual reality content.

Example 7 may include a semiconductor package apparatus, comprising a substrate, and logic coupled to the substrate, wherein the logic is at least partly implemented in one or more of configurable logic and fixed-functionality hardware logic, the logic coupled to the substrate to determine user-related concentration information, and adjust one or more parameters of a graphics subsystem based on the user-related concentration information.

Example 8 may include the apparatus of Example 7, wherein the logic is further to determine the user-related concentration information based on measured electroencephalograph information.

Example 9 may include the apparatus of Example 7, wherein the logic is further to adjust the one or more parameters to adjust a render quality of the graphics subsystem based on the user-related concentration information.

Example 10 may include the apparatus of Example 7, wherein the logic is further to adjust the one or more parameters to adjust one or more of an encode and a decode quality of the graphics subsystem based on the user-related concentration information.

Example 11 may include the apparatus of Example 7, wherein the logic is further to determine an increase in a level of concentration, and adjust the one or more parameters to increase one or more of a bandwidth, a resolution, and a frame rate of the graphics subsystem based on the increased level of concentration.

Example 12 may include the apparatus of any of Examples 7 to 11, wherein the graphics subsystem includes at least one of a render pipeline, an encode pipeline, and a decode pipeline for stereo virtual reality content.

Example 13 may include a method of adjusting a graphics parameter, comprising determining user-related concentration information, and adjusting one or more parameters of a graphics subsystem based on the user-related concentration information.

Example 14 may include the method of Example 13, further comprising determining the user-related concentration information based on measured electroencephalograph information.

Example 15 may include the method of Example 13, further comprising adjusting the one or more parameters to adjust a render quality of the graphics subsystem based on the user-related concentration information.

Example 16 may include the method of Example 13, further comprising adjusting the one or more parameters to adjust one or more of an encode and a decode quality of the graphics subsystem based on the user-related concentration information.

Example 17 may include the method of Example 13, further comprising determining an increase in a level of concentration, and adjusting the one or more parameters to increase one or more of a bandwidth, a resolution, and a frame rate of the graphics subsystem based on the increased level of concentration.

Example 18 may include the method of any of Examples 13 to 17, wherein the graphics subsystem includes at least one of a render pipeline, an encode pipeline, and a decode pipeline for stereo virtual reality content.

Example 19 may include at least one computer readable medium, comprising a set of instructions, which when executed by a computing device, cause the computing device to determine user-related concentration information, and adjust one or more parameters of a graphics subsystem based on the user-related concentration information.

Example 20 may include the at least one computer readable medium of Example 19, comprising a further set of instructions, which when executed by the computing device, cause the computing device to determine the user-related concentration information based on measured electroencephalograph information.

Example 21 may include the at least one computer readable medium of Example 19, comprising a further set of instructions, which when executed by the computing device, cause the computing device to adjust the one or more parameters to adjust a render quality of the graphics subsystem based on the user-related concentration information.

Example 22 may include the at least one computer readable medium of Example 19, comprising a further set of instructions, which when executed by the computing device, cause the computing device to adjust the one or more parameters to adjust one or more of an encode and a decode quality of the graphics subsystem based on the user-related concentration information.

Example 23 may include the at least one computer readable medium of Example 19, comprising a further set of instructions, which when executed by the computing device, cause the computing device to determine an increase in a level of concentration, and adjust the one or more parameters to increase one or more of a bandwidth, a resolution, and a frame rate of the graphics subsystem based on the increased level of concentration.

Example 24 may include the method of any of Examples 19 to 23, wherein the graphics subsystem includes at least one of a render pipeline, an encode pipeline, and a decode pipeline for stereo virtual reality content.

Example 25 may include a graphics apparatus, comprising means for determining user-related concentration information, and means for adjusting one or more parameters of a graphics subsystem based on the user-related concentration information.

Example 26 may include the apparatus of Example 25, further comprising means for determining the user-related concentration information based on measured electroencephalograph information.

Example 27 may include the apparatus of Example 25, further comprising means for adjusting the one or more parameters to adjust a render quality of the graphics subsystem based on the user-related concentration information.

Example 28 may include the apparatus of Example 25, further comprising means for adjusting the one or more parameters to adjust one or more of an encode and a decode quality of the graphics subsystem based on the user-related concentration information.

Example 29 may include the apparatus of Example 25, further comprising means for determining an increase in a level of concentration, and means for adjusting the one or more parameters to increase one or more of a bandwidth, a resolution, and a frame rate of the graphics subsystem based on the increased level of concentration.

Example 30 may include the apparatus of any of Examples 25 to 29, wherein the graphics subsystem includes at least one of a render pipeline, an encode pipeline, and a decode pipeline for stereo virtual reality content.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic processing system, comprising:
a processor;
a graphics subsystem communicatively coupled to the processor; and
logic communicatively coupled to the processor to:
determine user-related concentration information, and
adjust one or more parameters of the graphics subsystem based on the user-related concentration information.

2. The system of claim 1, wherein the logic is further to:
determine the user-related concentration information based on measured electroencephalograph information.

3. The system of claim 1, wherein the logic is further to:
adjust the one or more parameters to adjust a render quality of the graphics subsystem based on the user-related concentration information.

4. The system of claim 1, wherein the logic is further to:
adjust the one or more parameters to adjust one or more of an encode and a decode quality of the graphics subsystem based on the user-related concentration information.

5. The system of claim 1, wherein the logic is further to:
determine an increase in a level of concentration; and
adjust the one or more parameters to increase one or more of a bandwidth, a resolution, and a frame rate of the graphics subsystem based on the increased level of concentration.

6. The system of claim 1, wherein the graphics subsystem includes at least one of a render pipeline, an encode pipeline, and a decode pipeline for stereo virtual reality content.

7. A semiconductor package apparatus, comprising:
a substrate; and
logic coupled to the substrate, wherein the logic is at least partly implemented in one or more of configurable logic and fixed-functionality hardware logic, the logic coupled to the substrate to:
determine user-related concentration information, and
adjust one or more parameters of a graphics subsystem based on the user-related concentration information.

8. The apparatus of claim 7, wherein the logic is further to:
determine the user-related concentration information based on measured electroencephalograph information.

9. The apparatus of claim 7, wherein the logic is further to:
adjust the one or more parameters to adjust a render quality of the graphics subsystem based on the user-related concentration information.

10. The apparatus of claim 7, wherein the logic is further to:
adjust the one or more parameters to adjust one or more of an encode and a decode quality of the graphics subsystem based on the user-related concentration information.

11. The apparatus of claim 7, wherein the logic is further to:
determine an increase in a level of concentration; and
adjust the one or more parameters to increase one or more of a bandwidth, a resolution, and a frame rate of the graphics subsystem based on the increased level of concentration.

12. The apparatus of claim 7, wherein the graphics subsystem includes at least one of a render pipeline, an encode pipeline, and a decode pipeline for stereo virtual reality content.

13. A method of adjusting a graphics parameter, comprising:
determining user-related concentration information, and
adjusting one or more parameters of a graphics subsystem based on the user-related concentration information.

14. The method of claim 13, further comprising:
determining the user-related concentration information based on measured electroencephalograph information.

15. The method of claim 13, further comprising:
adjusting the one or more parameters to adjust a render quality of the graphics subsystem based on the user-related concentration information.

16. The method of claim 13, further comprising:
adjusting the one or more parameters to adjust one or more of an encode and a decode quality of the graphics subsystem based on the user-related concentration information.

17. The method of claim 13, further comprising:
determining an increase in a level of concentration; and
adjusting the one or more parameters to increase one or more of a bandwidth, a resolution, and a frame rate of the graphics subsystem based on the increased level of concentration.

18. The method of claim 13, wherein the graphics subsystem includes at least one of a render pipeline, an encode pipeline, and a decode pipeline for stereo virtual reality content.

19. At least one computer readable medium, comprising a set of instructions, which when executed by a computing device, cause the computing device to:
determine user-related concentration information, and
adjust one or more parameters of a graphics subsystem based on the user-related concentration information.

20. The at least one computer readable medium of claim 19, comprising a further set of instructions, which when executed by the computing device, cause the computing device to:
determine the user-related concentration information based on measured electroencephalograph information.

21. The at least one computer readable medium of claim 19, comprising a further set of instructions, which when executed by the computing device, cause the computing device to:
adjust the one or more parameters to adjust a render quality of the graphics subsystem based on the user-related concentration information.

22. The at least one computer readable medium of claim 19, comprising a further set of instructions, which when executed by the computing device, cause the computing device to:
adjust the one or more parameters to adjust one or more of an encode and a decode quality of the graphics subsystem based on the user-related concentration information.

23. The at least one computer readable medium of claim 19, comprising a further set of instructions, which when executed by the computing device, cause the computing device to:
determine an increase in a level of concentration; and
adjust the one or more parameters to increase one or more of a bandwidth, a resolution, and a frame rate of the graphics subsystem based on the increased level of concentration.

24. The method of claim 19, wherein the graphics subsystem includes at least one of a render pipeline, an encode pipeline, and a decode pipeline for stereo virtual reality content.
